(19) United States
(12) Patent Application Publication
(10) Pub. No.: US 2020/0334641 A1
(43) Pub. Date: Oct. 22, 2020

(54) SMART EVENT SUGGESTIONS BASED ON CURRENT LOCATION, CALENDAR AND TIME PREFERENCES

(71) Applicant: Microsoft Technology Licensing, LLC, Redmond, WA (US)

(72) Inventors: Rahul Singh, Seattle, WA (US); Stanley R. Ayzenberg, Seattle, WA (US); Jeff West, Seattle, WA (US)

(21) Appl. No.: 16/390,987

(22) Filed: Apr. 22, 2019

(51) Int. Cl. G06Q 10/10; G06N 20/00

(52) U.S. Cl. CPC G06Q 10/1095; G06Q 50/01; G06N 20/00

(57) ABSTRACT

Systems and methods are provided for enabling providing event suggestions based on input from a plurality of data sources including: user data including interests, travel modes and habits, calendar data including free/busy and location information associated therewith, map data including means for determining current and predicted traffic conditions and event data corresponding to a plurality of events from which recommendations are generated. Such data are received, and a travel radius is derived therefrom, the travel radius representing a predicted travel limit for the user based on, for example, past travel habits, transportation modes, predicted traffic, and the like. Interest weighting factors are also generated, and which represent a numeric representation of a user's interest profile. Such weighting factors and predicted travel radius may be applied to event data to generate event recommendations. Interest weighting factors and predicted travel radius may also be based on output from a reinforcement learning model.

### BACKGROUND

Living in a connected world can sometimes mean being overwhelmed by the sheer quantity of information accessible online. For example, although social networks may be adequate for keeping users apprised of developments in the news or with friends, it is possible or even likely that a lot of the information provided through such networks is not useful to such users. For example, social networks may help keep users informed about upcoming local events, but often do so in a shotgun manner that presents essentially a raw feed of all such local events to users. Presentation of events in this manner may force users to evaluate all local events to determine whether any are of interest. Manual review of an event feed is not only inefficient, but can also foster information overload whereby a user finds themselves unable to process all events or uninterested in doing so. Naturally, users in such a state of overload may miss events they may otherwise find interesting.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems and computer program products are provided that address limitations of current event recommendation systems. In aspects, methods are provided that enable event recommendations to be generated based on various types of data. In an embodiment, user data regarding the user, calendar data corresponding to the user, map data, and event data are received. In embodiments, user data may comprise messaging and social media data, interests, contacts and/or user demographic data. In embodiments, calendar data may include free/busy information corresponding to the user as well as location information corresponding to such free/busy information. In embodiments, map data may include navigation/travel preferences, frequently visited locations, and/or a current location. For example, navigation/travel preferences may include a person's preferred mode of transportation or navigation, i.e., driving vs. walking vs. transit. In another embodiment, map data may include data that enables determination of points of interest, travel directions, and current or future traffic conditions. In embodiments, event data comprises information about upcoming events and may include a count of the number of interested people, the view count of the event, event duration, and other event attributes. In an embodiment, a likely travel radius of the user is determined based on the user, calendar data, and event data. In another embodiment, interest weighting factors are determined based on the user, calendar, map, and event data. In another embodiment, successive filtering operations are performed against the event data using the determined travel radius, interest factors and calendar data to generate event recommendations.

In one implementation, an event recommendation system includes one or more processors, one or more memory devices coupled to the processors and storing processor instructions defining components. In an embodiment, such components may include a radius determiner, an interest parser, and an event filter. In another embodiment, the system further includes a reinforcement learning component including a machine learning model that may be configured to accept feedback from the user after attending a selected event that may include, for example, a rating of the event, and the time spent at the event. The machine learning model is updated based on such feedback, and may be used in part by the radius determiner and interest parser.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a schematic view of an event suggestion system coupled to example data sources and configured to generate suggested events, according to an embodiment.

FIG. 2 depicts a detailed schematic view of an event suggestion system, according to an embodiment.

FIG. 3 depicts a flowchart of a method for generating event suggestions, according to an embodiment.

FIG. 4 depicts a flowchart of refinements to the flowchart of FIG. 3, including a flowchart of a method for generating calendar event entries in response to an event selection, according to an embodiment.

FIG. 5 depicts a flowchart of a refinement to the flowchart of FIG. 3 for updating a machine learning model according to feedback data, according to an embodiment.

FIG. 6 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Currently, websites that provide local event suggestions either provide a raw feed of all local events or use some past behaviors to create event recommendations for users. Such recommendation techniques, however, lack personalization. Accordingly, embodiments are configured to provide much more personalized recommendations using various input data, including using input data sources such as the user's calendar, preferences for how far the user is willing to travel for events, and how long they are willing to spend at them.

In embodiments, an event recommendation system/service is configured to suggest activities to the user based on their current location, calendar information, and past events that they may have attended, and optionally further information. The service may maintain a list of events that is constantly being updated algorithmically through things like web crawlers and also by human curators. The service may also maintain a personalized machine learning (ML) model for each user that may be constantly fine-tuned based on which events a particular user is interested in or attends. This model may be harnessed to narrow down events to those that might actually be relevant to the user from the entirety of events in the service's directory. The service may then determine the user's current location, and based on how far the user usually travels to attend events, narrow down the personalized list of events even further. In an alternative embodiment, the user may directly configure a maximum distance he/she is willing to travel. Still further, the service may examine the user's calendar and assign higher weights to the events that occur when the user does not already have an appointment on their calendar. Finally, the user may provide the service input regarding how long they are willing to spend on events on that particular occasion. This data point may be used to remove any events that might be longer than the user's preference. The resultant list is generated that is highly individualized to that particular user's interests, location, calendar, past event history, and how much time they are willing to spend at events. Users may also elect to share their experiences with others (e.g., friends, public lists, etc.) to allow their own preferences to be used as data points for fine-tuning suggestions to other users with similar interests or time allocations. In embodiments, a user may likewise elect to allow the use of their personal experiential data to improve suggestions for all users.

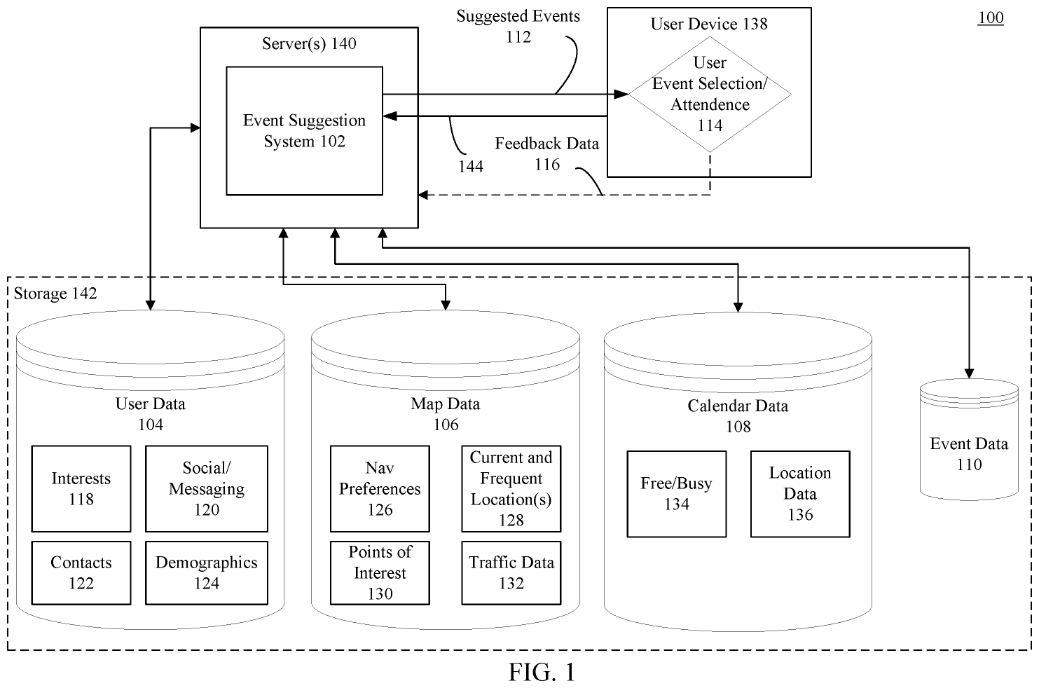

These and further embodiments of generating event recommendations may be implemented in various ways. For example, FIG. 1 depicts a schematic view 100 of an example event suggestion system 102 that includes a user device 138, one or more servers 140, and storage 142, according to an embodiment. As shown in FIG. 1, suggestion system 102 is coupled to example data sources 104, 106, 108, and 110 in storage 142, and is configured to generate suggested events 112. Other structural and operational embodiments will be apparent to persons skilled in the relevant art(s) based on the following discussion regarding schematic view 100 of FIG. 1.

In embodiments, event suggestion system 102, as described in greater detail below, may be embodied in one or more of computing device(s) 140, such as one or more servers. Such server(s) may optionally be included, for example, in a network-accessible server infrastructure. In an embodiment, the server(s) may form a network-accessible server set, such as a cloud computing server network. Such servers may comprise a group or collection of servers that are each accessible via a network such as the Internet (e.g., in a “cloud-based” embodiment) to store, manage, and process event recommendations.

User device 138 is a device of a user that desires to receive an event recommendation from event suggestion system 102. In particular, user device 138 may generate an event suggestion request 144 automatically (e.g., when user device 138 reaches a particular location or geographic region, at a predetermined time, on a periodic basis, etc.), due to user input at a user interface of user device 138, or based on another trigger. Event suggestion system 102 is configured to generate suggested events 112, which includes one or more suggested events for the user at user device 138. Event suggestion system 102 may generate suggested events 112 in an automatic manner (e.g., when determining user device 138 reaches a particular location or geographic region, at a predetermined time, on a periodic basis, etc.), in response to request 144, or based on another trigger.

User device 138 and server(s) 140 may be communicatively coupled by a network, which may comprise one or more networks such as local area networks (LANs), wide area networks (WANs), enterprise networks, the Internet, etc., and may include one or more of wired and/or wireless portions. Examples of user device 138 include, but are not limited to, a mobile device that is carried by and/or worn by the user, such as a notebook computer, a laptop computer, a tablet computer such as an Apple iPad™, a mixed device (e.g., a Microsoft® Surface® device), a netbook, a mobile phone (e.g., a cell phone, a smart phone such as an Apple iPhone®, a phone implementing the Google® Android™ operating system, etc.), a smart watch, a head-mounted device including smart glasses such as Google® Glass™, Oculus Rift® by Oculus VR, LLC, etc., an augmented reality headset including Microsoft® HoloLens™, another type of wearable computing device, etc. Any number of user devices 138 may be present that are communicatively coupled to server(s) 140 to receive event recommendations from event suggestion system 102.

In an embodiment, event suggestion system 102 may be coupled to data sources shown in FIG. 1, including user data 104, map data 106, calendar data 108 and event data 110. As shown in FIG. 1, data sources 104, 106, 108, and 110 are included in storage 142. Storage 142 may include one or more of any type of suitable storage medium, such as a hard disk, solid-state drive, magnetic disk, optical disk, read-only memory (ROM), or random-access memory (RAM). Note storage 142 may be maintained at a single storage location (e.g., with server(s) 140) or may be distributed (e.g., a portion of storage 142 included in user device 138 and another portion included with server(s) 140. In particular, any one or more of data sources 104, 106, 108, and 110, or any portion thereof, may be maintained in storage at server(s) 140 and/or at user device 138, as desired. Each of the types of data sources 104, 106, 108, and 110 are now discussed in turn.

In embodiments, user data 104 may include many types of per-user data including, but not limited to, interests 118, social network/messaging data 120, contacts 122 and demographic data 124. Interests 118 may comprise, for example, a list of topics, activities, hobbies, books, TV shows, movies and/or movie genres, music and/or musical acts and bands etc. That is, interests 118 may comprise any and all of the express or implied interests of a user. In embodiments, event suggestion system 102 may be configured to query a user for a list of their interests. In other embodiments, and as discussed in more detail below, event suggestion system 102 may collect and process other types of data to help determine the interests of a user. It should be appreciated that the enumerated categories for interests 118 are mere examples, and events may be related to myriad different user interests.

For example, social network/messaging data 120 may be used to help determine an interest profile for a user (i.e., the topics, activities or things of greatest interest to a user). Social network/messaging data 120 may include all data related to a social network account associated with a user. For example, social network/messaging data 120 may include friend and/or contact lists and post/activity histories. In other embodiments, social network/messaging data 120 may provide data regarding friends and family of the user who may be attending an event, thereby increasing the likelihood the system may recommend that event to the user. Social network/messaging data 120 may also include, however, data that is not strictly associated with a social network such as, for example, email data, SMS/MMS data and/or instant messaging data. As will be discussed in more detail below, social network/messaging data 120 may be useful for determining event recommendations by, for example, enabling automatic or semi-automatic determination of user interests, rather than require rote entry of interests by the user. One of skill in the relevant art(s) will appreciate that the abovementioned types of social network/messaging data 120 are mere examples. Social network/messaging data 120 may be maintained by or obtained from a social network, such as Facebook® operated by Facebook, Inc. of Palo Alto, Calif., Twitter, Inc. of San Francisco, Calif., LinkedIn, operated by Microsoft Corporation of Redmond, Wash., etc.

In embodiments, user data 104 may also include contacts 122. Contacts 122 may include any listing of user contacts. For example, and as discussed above, contacts 122 may include social network friend lists. However, contacts 122 may also include any other listings of user contacts such as, for example, email contacts stored in an email client such as Microsoft® Outlook® and/or Hotmail. Note, such examples of suitable contact data are merely exemplary and additional types and sources for contacts 124 may be employed, in embodiments.

In other embodiments, user data 104 may also include user demographic data 124. For example, event suggestion system 102 may solicit voluntary disclosure of personal demographic information from a user. Such demographic data 124 may include, for example, age, race, gender, income, marital status and/or disability status. Demographic data 124 may then be used in part to help determine the user's interest profile and/or travel radius. Again, such examples of suitable demographic data are merely exemplary and additional types of demographic data 124 may be employed, in embodiments. Demographic data 124 may be maintained in a user account of the user or elsewhere, and may be provided by permission of the user (e.g., opting in, etc.).

Map data 106 as shown in FIG. 1 may also be accessed or otherwise consumed by event suggestion system 102, in embodiments. Map data 106 may comprise, for example, per-user data (i.e., data specific to a particular user) relating to location, navigation, travel preferences, and the like. For example, map data 106 may comprise user navigation preferences 126, or current and/or frequent user location(s) 128. Navigation preferences 126 may reflect, for example, the travel preferences or habits and/or the typical or preferred transportation modes of a user. For example, navigation preferences 126 may include data corresponding to a user indicating that the user always travels by bus during the week, but may prefer to use a car on the weekends. Likewise, navigation preferences 126 may reflect typical or necessary routes used by a particular user. Navigation preferences 126 may also include historical travel information. In particular, navigation preferences 126 may include a set of distances that the user has traveled in the past to attend events. The set of distances may be processed further to determine, for example, a minimum, maximum, average or weighted average of distances traveled to events. As will be discussed in more detail below, such navigation preferences 126 may be used by embodiments to estimate how far a user is likely to travel to attend a suggested event. This determined measure of distance is referred to herein as “travel radius”. The aforementioned examples of navigation preferences 126 do not comprise an exhaustive list, and other types of navigation preferences 126 are within the spirit and scope of the disclosure.

Map data 106 may also include per-user data such as current and/or frequent user location(s) 128. Such locations may likewise be used in part to determine both a travel radius and/or interest profile as will be discussed in greater detail herein below. Of course, other types of user location information may be employed in embodiments, and the discussed examples ought not be construed as limiting.

Map data 106 may also include more general map-related data that may not be strictly related to a particular user, or may be related to that user only by virtue of their current or expected location. For example, and as depicted in FIG. 1, map data 106 may include points of interest 130 or traffic data 132. Points of interest 130 may comprise, for example, a list of points of interest near a current or expected location, where a point of interest is a specific location that a user may find useful or interesting. For example, and particularly when traveling, a user may consider gas stations and hotels to be points of interest. In other cases, points of interest may comprise locations popular with vacationers/tourists. The types of points of interest 130 as discussed herein above are merely exemplary, and other types are possible in embodiments.

Also as shown in FIG. 1, map data 106 may include traffic data 132. Traffic data 132 may include, for example, any data that reflects the current or predicted future traffic conditions of, e.g., a location, route or destination. Strictly speaking, traffic data 132 is not user-specific in that it is tied to specific map locations, times of day and days of week. However, in embodiments, such data may by useful only in the context of, for example, other user-specific map data such as current or frequency location(s) 128, or as will be discussed more below, calendar-related location data. In embodiments, traffic data 132 may also comprise an application programming interface (“API”) or other means for accessing, retrieving or otherwise obtaining current or predicted future traffic conditions pertaining to a route. Other types of traffic data 132 are also possible as will be understood by those of skill in the relevant art(s). Map data 106 may be maintained in association with a user account of the user, by a mapping tool accessed by the user (e.g., Google™ Maps, etc.), or otherwise.

As shown in schematic view 100 of FIG. 1, event suggestion system 102 may also be configured to access calendar data 108. In embodiments, calendar data 108 is user-specific since it corresponds to the calendar data of a particular user (e.g., maintained by a calendar tool of the user at user device 138, by a cloud-server of the calendar tool, etc.). Calendar data 108 may include, in embodiments, free/busy data 134. Free/busy data in its simplest form reflects whether the user is busy during a particular time slot on a particular day, and often available free/busy data for a user reflects only such information, and does not reflect any specific information about what a user is doing during a “busy” period of time (for privacy reasons). For certain types of calendaring systems, however, users may optionally publish detailed calendar data including identification of scheduled events or meetings, and their locations.

Schematic 100 of FIG. 1 further depicts event suggestion system 102 receiving event data 110. In embodiments, event data 110 may comprise any data or metadata corresponding to a collection of future events that may be recommended to a user. For example, data regarding an event may include the event name, date, time and location, as well as keywords related to the content of the event to correlate with a user interest profile (and as will be discussed in more detail below). Event data 110 may be collected or generated in various ways. For example, embodiments may employ a suitably configured web crawler to collect event information from publicly available sources on the Internet. For example, various organizations may publish calendars of events related relevant to organization members. In addition to public sources for event data, embodiments may be configured to receive non-public event data. For example, large companies often have a number of events occurring on, for example, the company campus on any given day, and data regarding such events may be provided to embodiments of event suggestion system 102 as event candidates.

Event data 110 may also include attributes and statistics for each event. For example, event data 110 may include a measure of interest in an event. Such interest may be reflected, for example, by page views on related web sites or news stories, web search statistics, and the like.

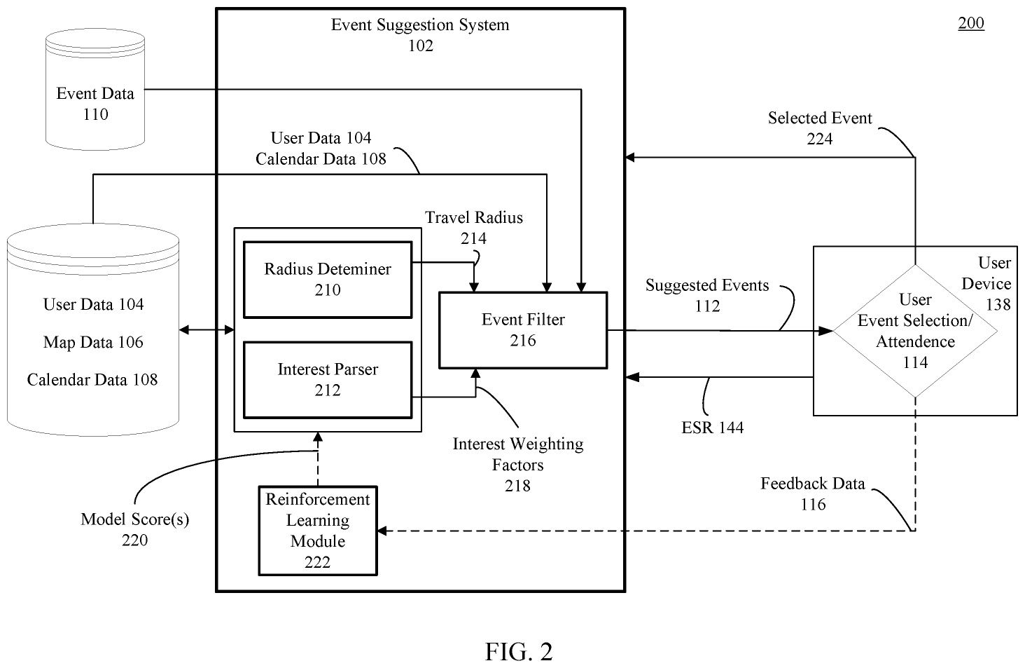

Embodiments of event suggestion system 102 may be implemented in various ways to use the aforementioned data to generate event recommendations to a user. For example, FIG. 2 depicts a detailed schematic view 200 of event suggestion system 102 in communication with user device 138, according to an embodiment. As shown in FIG. 2, event suggestion system 102 includes a radius determiner 210, an interest parser 212, an event filter 216 and a reinforcement learning module 222. Server(s) 140 and storage 142 are not shown in FIG. 2 for ease of illustration. Other structural and operational embodiments will be apparent to persons skilled in the relevant art(s) based on the following discussion regarding event suggestion system 102 as depicted in FIG. 2.

As an initial matter, and as discussed above, event suggestion system 102 as shown in FIG. 2 is configured to receive user, map, calendar and event data 104-110, respectively. Embodiments of event suggestion system 102 may operate on such data to generate suggested events in the following general manner.

First, each of radius determiner 210 and interest parser 212 receive user, map and calendar data 104-108, respectively. Radius determiner 210 operates on the received data to determine a travel radius 214, whereas interest parser 212 operates on the data to determine interest weighting factors 218.

Second, travel radius 214 and interest weighting factors 218 (in addition to user data 104 and calendar data 108) are in turn provided to event filter 216, in embodiments. Event filter 216 also receives event data 110 and is configured to utilize travel radius 214 and interest weighting factors 218 to perform filtering operations on event data 110. Upon completion of the filtering operations, event filter 216 outputs suggested events 112.

The operation of example embodiments of each of radius determiner 210, interest parser 212 and event filter 215 will now be discussed in turn immediately below, followed thereafter by a discussion of alternative embodiments that include reinforcement learning module 222.

In embodiments, radius determiner 210 is configured to accept user data 104, map data 106 and calendar data 108 and determine travel radius 214 based on such data each time a set of event recommendations is generated. As discussed above, travel radius 214 represents a best estimate of how far a particular user would be willing to travel to attend an event. Rather than assume a fixed or otherwise pre-determined travel radius for a user, embodiments of radius determiner 210 are configured to determine a likely travel radius in the context of all available data. Because the underlying data changes over time, embodiments of radius determiner 210 offer event suggestion system 102 a context sensitive means for applying travel distance-based filter criteria that may be established and enforced every time a set of event recommendations is generated.

In embodiments, the travel radius 214 may itself reflect an amount of time available (i.e., the determined travel radius is smaller when the user has less time available during, for example, a given time slot on a particular day). Alternatively, the value of travel radius 214 may be notional, reflecting only how far a user may be willing to go when other considerations are set aside, and time constraints may instead be enforced at a later stage during the operation of event filter 216, and as will be discussed in more detail below.

The abovementioned data may be used by radius determiner 210 in various ways. In embodiments, data applicable to the problem of radius determination can militate either in favor of or against a larger radius. For example, contacts 122 and/or a friends list that may be part of social network/messaging data 120 (each included in user data 104) may allow inferences regarding how far a user is willing to travel. In this example, it may be presumed that a user would be willing to travel further to attend an event that will be attended by friends and/or relatives. Embodiments may likewise infer a relationship between distances and the number of such friends/relatives that will attend.

For each of the categories of data discussed herein below, embodiments may be configured to assign a score to each piece a data and sum the score wherein the score is a measure of how far the user may be willing to travel. The actual scores and weights to be assigned to each data type may be determined on an ad hoc, trial and error basis to develop a heuristic. Alternatively, embodiments may employ a machine learning model that accepts such data to produce a distance or score suitable for transforming to an actual distance. In either case, the machine learning model or heuristic may be updated over time to reflect events from among the suggested events that are actually selected and attended. In embodiments, a machine learning model may be maintained for each user and which reflects the particular choices of only that user. Alternatively, a machine learning model may be maintained that reflects the aggregate choices of a larger user base (i.e. all users from a particular location or company). Of course, embodiments are possible that employ models based both on per-user and aggregate data. What follows herein immediately below is a discussion of the various data that may be considered by embodiments, and how such data favors a greater or lesser generated travel radius 214.

In addition to contacts 122 and/or friend lists of social network/messaging data 120, demographic data 124 is a type of user data that embodiments may consider when determining travel radius 214. In an embodiment, a user's disability status may be considered when determining the travel radius 214. For example, where a user has a disability that effects mobility, such a user may be less able or willing to travel which of course militates in favor of a smaller travel radius 214.

Map data 106 may also be used in numerous ways to determine travel radius 214. For example, and as discussed above, navigation preferences 126 of map data 106 may include the travel preferences/habits and/or the typical or preferred transportation modes of a user. Travel radius 214 will of course be limited when a user indicates a preference for walking or biking, for example. Where travel habits of navigation preferences 126 indicate a mid-week reliance on transit (and a corresponding lack of a car), travel radius 214 will also tend to be smaller. Also as discussed above, navigation preferences 126 may include a set of distances that the user has traveled in the past to attend events. Such distances are likely to be a good indicator of how far a user will travel, all else being equal. Embodiments may likewise use other measures derived from the set of travel distances (e.g., a minimum, maximum, average or weighted average of distances traveled).

Current/frequent locations 128 of map data 106 may reflect the fact that a particular user is always downtown on weekdays (and thus more likely to attend events downtown), whereas the same user is almost always in the suburbs at or near their residence on the weekends. Presumably may be less likely to travel too great a distance from their residence on the weekends, absent some countervailing happenstance (e.g., the user's favorite band is playing, or some very rare event is occurring). On the other hand, though a particular user may frequently be in the suburbs on the weekend, it may be the case that such a user is in fact downtown on, for example, a particular Saturday. In such instances, embodiments may be configured to recognize that the user's current location ought to have a strong effect on any event recommendations generated by event suggestion system 102.

Points of interest 130 of map data 106 may militate in favor of predicting a larger travel radius 214 in certain circumstances particularly where travel radius 214 is expanded to include relatively large numbers of points of interest 130. Such an expansion of travel radius 214 may be justified, in embodiments, where a user may be more likely to attend events close to such points of interest in order to take advantage of travel efficiencies offered. That is, a user may be more likely to attend a two-hour event in a nearby location if, while they are there, they can easily attend other events or visit one or more points of interest 130 before or after the event.

Traffic data 132 included in map data 106 also can significantly impact travel radius 214 at certain locations and at certain times of day. It can be appreciated that a person may travel only relatively limited distances in a given period of time when traffic is or anticipated to be heavy. Thus, current or future traffic conditions between within an area will be a factor in travel radius 214.

In embodiments, and as mentioned above, traffic data 132 may include per-user traffic data including a set of distances previously traveled by the user to attend events. Of course, the amount of time required to travel such distances may also be included in traffic data 132. When future travel between roughly the same locations is considered, such historical traffic data 132 may inform the determination of travel radius 214.

In embodiments, traffic data 132 may also include aggregate data from multiple users. That is, embodiments may aggregate historical per-user data to adjust future recommendations. Embodiments may be configured to recognize that, for example, ten users traveled between two locations using the same bus route, and further recognize that the time estimate for the trip as reflected in traffic data 132 was inaccurate by some N minutes. In such instances, future recommendations generated by event suggestion system 102 may build the N minute error into travel time assumptions, in an embodiment. Of course, predicted future traffic conditions included in traffic data 132 may themselves already reflect typical delays along a route in which case such corrections may not be necessary. In any event, this type of aggregated user data is merely exemplary, and other types of user data may be aggregated.

In addition to user data 104 and map data 106, calendar data 108 is likewise relied upon by embodiments of event suggestion system 102 for determining travel radius 214. For example, location data 136 of calendar data 108 may be usefully employed to help determine travel radius 214. As discussed above, location data 136 of calendar data 108 corresponds to the locations of previously scheduled meetings or other events on a user's calendar and may in some cases be gleaned from that user's calendar. As with the current location as reflected in map data 106, location data 136 of calendar data 108 may be used at least in part to help determine whether a given event recommendation is feasible to make for that user. For example, suppose a user has a one-hour lunch seminar to attend at work, and a meeting to attend at work at 3 p.m. in the afternoon. With only a two-hour window between meetings at work, embodiments provided with such calendar data would be less likely to recommend events that could require more than the two-hour window (particularly given traffic and/or travel mode constraints described above). That is, the travel radius 214 determined when generating suggested events 112 for a particular timeslot may take advantage of a predicted future location as reflected in location data 136 of calendar data 108. Having discussed the various ways radius determiner 210 may use data to determine travel radius 214, discussion now turns to interest parser 212.

As mentioned above, embodiments of interest parser 212 included in event suggestion system 102 are configured to accept user data 104, map data 106 and calendar data 108 and determine an interest profile for the user. The interest profile reflects not only the interests of the user, but also a measure of the strength of such interests. In an embodiment, such measures are reflected in interest weighting factors 218. Interest weighting factors 218 represent the relative strengths of various user interests. In an embodiment, interest weighting factors 218 may comprise ordered pairs of interests coupled with their strengths. In an embodiment, a strength may be a number between 1 and 10 where a 1 represents the mildest measure of an interest, and a 10 represents the top most priority for an interest. For example, supposing that a user's favorite hobby is needlepoint, an interest weighting factor for that interest could be a 10 and represented as the ordered pair {needlepoint, 10}. The same user may have only a slight or only passing interest in home plumbing repair with an interest weighting factor of {plumbing, 1}. As discussed above, interests may be solicited directly from a user, along with their measure of interest in each topic. In embodiments, however, interest parser 212 may operate on the abovementioned data to automatically or semi-automatically determine interest weighting factors 218 for that user.

For example, interest parser 212 may receive social network/messaging data 120 and analyzes communications included in such data to reveal patterns of interests. Suppose, for example, that historically a user has shared or re-shared numerous messages or event notices with their social network related to, for example, electric vehicles. A reasonable inference may be drawn from such historic communication that the user may have an interest in events related to electric vehicles. Moreover, social network/messaging data 120 may reflect the co-interests of a relatively large cross section of the user's social network, and again thereby more reliably predict events that may be of interest to a user since, for example, an event attended by a large number of friends is likely to be of greater interest to a user.

Similarly, contacts 122 included in user data 104 may be useful for determining an interest profile since events to be attended by one or more of a user's contacts presumably may be of greater interest to a user.

Demographic data 124 is another type of user data 104 that can be used to determine interest weighting factors 218. For example, a married person is much less likely to be interested in an event that caters to single people in the dating scene. Likewise, a high schooler is probably not going to be interested in attending events at 21 and over venues.

In embodiments, interest parser 212 may be configured to process such data in a manner analogous that that described above in relation to event data 110. In particular, data received by interest parser 212 may be processed according to manually determined heuristic weightings to generate interest weighting factors 218. Alternatively, in embodiments, interest parser 212 may operate in conjunction with one or more machine learning models to process user data 104, map data 106 and calendar data 108 to produce interest weighting factors 218. Embodiments may thereafter update the machine learning model according to feedback data provided thereto. For example, and as will be discussed in more detail below, a user may provide feedback about one or more attended events that may be incorporated into the machine learning model, and which causes event suggestion system 102 to make greater or fewer similar recommendations in the future, in embodiments.

As mentioned above, travel radius 214 and interest weighting factors 218 as generated by radius determiner 210 by interest parser 212, respectively, are thereafter provided to event filter 216 for determination of suggested events 112. Event filter 216 may be configured in numerous ways to produce suggested events 112. As mentioned above, embodiments of event suggestion system 102 may be configured to also provide user data 104 and calendar data 108 to event filter 216. Thereafter, embodiments of event filter 216 may apply a series of filtering operations to the event data 110 using travel radius 214, interest weighting factors 218, user data 104 and calendar data 108 to produce suggested events 112.

For example, event data 110 may first be filtered according to the determined travel radius 214. That is, each event in event data 110 that is outside the determined travel radius 214 may be eliminated as a candidate for presentation as suggested events 112. In an embodiment, event filter 216 may thereafter apply a second filtering operation against the remaining event candidates of event data 110, as output by the first filtering operation described immediately above. For example, event filter 216 may use calendar data 108 to apply the second filtering operation to the output of the first filtering operation thereby eliminating event candidates that are in conflict with existing meetings, events or other obligations reflected in the user's calendar data. Embodiments of event filter 216 may thereafter use the remaining event candidates output from the second filtering operation to perform a third filtering operation. For example, event filter 216 may use the interest weighting factors 218 to filter the remaining event candidates according to user interests. In particular, events that are insufficiently related to user interests as reflected by a low or nonexistent score in interest weighting factors 218 may be filtered out by embodiments of event filter 216 when compared against the events in event data 110. The output of the third filtering operation comprises some or all of suggested events 112, in embodiments.

It should be understood, however, that in embodiments the above described filter operations may occur in a different order. For example, free/busy data may be applied to event data as a threshold matter since, no matter the value of travel radius 214, and no matter how much interest a user may have in an event, free/busy data may indicate a conflict during a particular time, and it may be more efficient to rule out conflicting events early.

However, in yet another embodiment, an indicated firmness of a particular calendar entry may be used to flag to event filter 216 whether to apply early or late filtering based on free/busy data. For example, where a meeting invitation was only tentatively accepted, embodiments may be configured to include events in suggested events 112 that overlap with the time slot. For invitations that are accepted in other manners, however, embodiments may be configured to ignore events that overlap or correspond to a configurable buffer zone before or after the meeting.

Having described the generation of suggested events 112 by event suggestion system 102, discussion will now turn to operational aspects of event suggestion system 102 that occur after such generation. In particular, operations that may be performed by embodiments of event suggestion system 102 after suggested events 112 are provided to the user. With continued reference to event suggestion system 102 of FIG. 2, a user may select and subsequently attend an event of suggested events 112 at decision block 114. Upon selection of an event from among those of suggested events 112, selected event 224 may be provided to or otherwise noted by event suggestion system 102. In embodiments, event suggestion system 102 may be configured to thereafter generate a meeting request or otherwise provide a calendared reminder to the user. In an embodiment, event suggestion system 102 may be provided with direct access to the user's calendar, and save a placeholder directly. In other embodiments, however, event suggestion system 102 may send an email with a meeting request to the user that may be accepted and calendared in the ordinary manner.

After selection and calendaring of an event of suggested events 112, the user may ordinarily attend the selected event (e.g., carrying user device 138 with the user). After attendance by the user, feedback data 116 may be provided from user device 138 to event suggestion system 102 for further processing. For example, a client application on user device 138 may be configured to automatically gather data related to the attendance by the user of the selected event. For example, user device 138 may be aware of the manner and timing of the user's transportation to the event (e.g., by location determination by GPS (global positioning system) or monitoring location in another manner, by user input to a user interface, etc.). Likewise, user device 138 may gather information about how long the user spent at the event location. Such data may be useful for updating assumptions relied upon by embodiments of event suggestion system 102 for generating suggested events 112. For example, it may be the case that the trip to the event took longer than anticipated due to local conditions and that future suggested events 112 should reflect a smaller travel radius 214. Alternatively, a short stay at the event may serve as a proxy of user interest. That is, if the user stays at the event site for only one hour of a two-hour event, it may be inferred that the event was not very good or interesting. Likewise, a user device 138 could also prompt the user for direct feedback about the event (e.g., ask for a rating or provide a satisfaction survey). Such feedback data 116 may thereafter be provided to event suggestion system 102 for use by reinforcement learning module 222.

In embodiments, reinforcement learning module 222 may be configured to accept feedback data 116 and to produce model score(s) 220. In embodiments, model score(s) 220 may be produced by a machine learning model included in reinforcement learning module 222, where such scores related to, for example, travel times or other types of map data 106, or related to a user interest in the event. Model score(s) 220 may thereafter be relied upon by either radius determiner 210 or interest parser 212 (or both) for producing travel radius 214 and interest weighting factors 218, respectively.

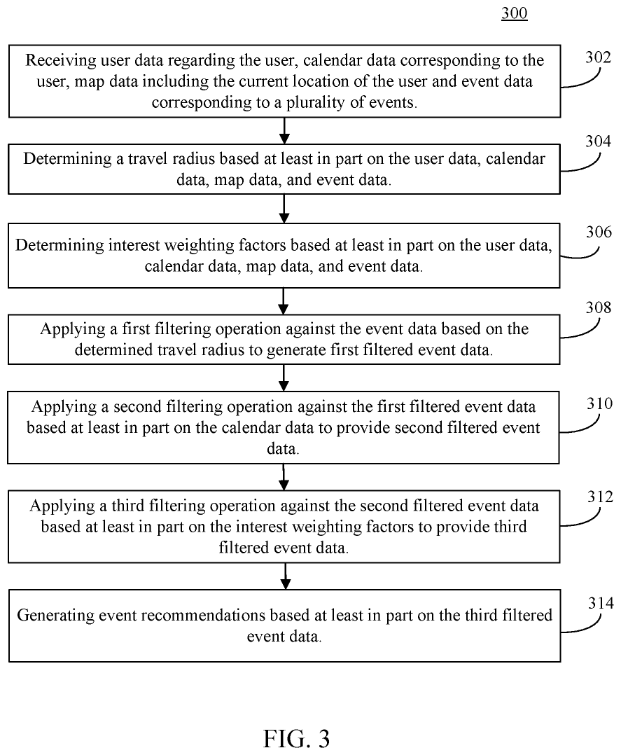

Further operational aspects of event suggestion system 102 of FIGS. 1 and 2 will now be discussed in conjunction with FIG. 3 which depicts a flowchart 300 of an example method for generating event suggestions, according to an embodiment. In an embodiment, flowchart 300 may be performed by event suggestion system 102 of FIG. 1 and of FIG. 2. Although described with reference to system 102 as shown in FIG. 2, the method of FIG. 3 is not limited to that implementation. Other structural and operational embodiments will be apparent to persons skilled in the relevant art(s) based on the following discussion regarding event suggestion system 102 of FIG. 2.

Flowchart 300 is an example method for generating event suggestions, according to an embodiment. Note that flowchart 300 may be triggered to generate an event suggestion/recommendation for a user of user device 138 in various ways, such as in response to receiving event suggestion request 144 from user device 138 or automatically (e.g., based on a time of day, on a periodic basis, in response to a location change and/or a reached destination determined for user device 138 (e.g., based on receiving location information from user device 138), due to one or more new events being announced, due to a change in user interests indicated by the user, etc.).

Flowchart 300 begins at step 302. At step 302, user data regarding the user, calendar data corresponding to the user, map data including the current location of the user and event data corresponding to a plurality of events is received. For example, and with reference to event suggestion system 102 of FIG. 2, radius determiner 210 and interest parser 212 may be configured to receive user data 104, map data 106 and calendar data 108. Likewise, event filter 216 may be configured to receive user data 104 and calendar data 108. Flowchart 300 of FIG. 3 continues at step 304.

In step 304, a travel radius is determined based at least in part on the user data, calendar data, map data, and event data. For example, and with continued reference to event suggestion system 102 of FIG. 2, radius determiner 210 may be configured to generate travel radius 214 based at least in part on user data 104, map data 106 and event data 110 in the manner described in detail above, in an embodiment.

In step 306, interest weighting factors based at least in part on the user data, calendar data, map data, and event data are determined. For example, and with continued reference to event suggestion system 102 of FIG. 2, interest parser 212 may be configured to generate interest weighting factors 218 based at least in part on user data 104, map data 106 and event data 110 in the manner described in detail above, in embodiments. Flowchart 300 continues at step 308.

At step 308, a first filtering operation is applied against the event data based on the determined travel radius to generate first filtered event data. For example, and with continued reference to event suggestion system 102 of FIG. 2, event filter 216 may be configured to apply travel radius 214 to event data 110 in the manner described in detail above to eliminate events that are outside the determined travel radius 214, in embodiments. The events of event data 110 that were not eliminated by the first filtering operation comprise first filtered event data as described above. Flowchart 300 continues at step 310.

At step 310, a second filtering operation is applied against the first filtered event data based at least in part on the calendar data to provide second filtered event data. For example, and with continued reference to event suggestion system 102 of FIG. 2, event filter 216 may be configured to apply calendar data 108 to the output of the first filtering operation described immediately above in conjunction with step 308, and in the manner described in detail above regarding event filter 216, to eliminate events that would conflict with exiting meetings, events or other obligations. Also as described above, the output of the second filtering operation comprises second filtered event data. Flowchart 300 continues at step 312.

At step 312, a third filtering operation is applied against the second filtered event data based at least in part on the interest weighting factors to provide third filtered event data. For example, and with continued reference to event suggestion system 102 of FIG. 2, event filter 216 may be configured to apply interest weighting factors 218 to the output of the second filtering operation described immediately above in conjunction with step 310, and in the manner described in detail above regarding event filter 216, to eliminate events that do not match user interests as reflected in interest weighting factors 218. Also as described above, the output of the third filtering operation comprises third filtered event data.

Flowchart 300 of FIG. 3 concludes at step 314. In step 314, event recommendations are generated based at least in part on the third filtered event data. For example, and with continued reference to event suggestion system 102 of FIG. 2, event filter 216 may be configured to provide some or all of the output of the third filter operation described immediately above in conjunction with step 310 as suggested events 112.

As shown in FIGS. 1 and 2, suggested events 112 may be transmitted from event suggestion system 102 to user device 138 for presentation to the user (e.g., by display on a graphical user interface, by voice audio, etc.). At user device 138, the user may be enabled to select a suggested event from suggested events 112. For instance, user device 138 may provide a description of each suggested event of suggested events 112 (e.g., a title, a summary, a location, etc.), and may provide one or more links for each suggested event that the user may interact with to obtain further information for corresponding events (e.g., a link to a website for an event, etc.). Furthermore, the user may be enabled to confirm their attendance to a suggested event, purchase tickets, etc., as desired.

In the foregoing discussion of steps 302-314 of flowchart 300, it should be understood that at times, such steps may be performed in a different order or even contemporaneously with other steps. For example, the filtering steps 308-312, respectively, may be performed in a different order. Other operational embodiments will be apparent to persons skilled in the relevant art(s). Note also that the foregoing general description of the operation of event suggestion system 102 is provided for illustration only, and embodiments of event suggestion system 102 may comprise different hardware and/or software, and may operate in manners different than described above. Indeed, steps of flowchart 300 may be performed in various ways.

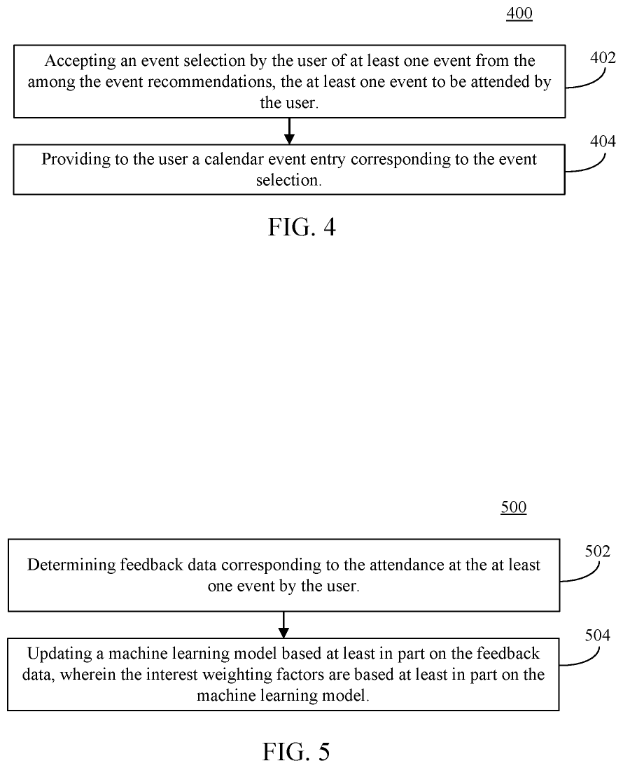

For example, FIG. 4 depicts a flowchart 400 of an additional example method of generating event suggestions, according to an embodiment, and wherein flowchart 400 comprises refinements or additions to the method steps of flowchart 300 as depicted in FIG. 3. Accordingly, flowchart 400 of FIG. 4 will also be described with continued reference to event suggestion system 102 of FIG. 2. However, other structural and operational embodiments will be apparent to persons skilled in the relevant art(s) based on the following discussion regarding flowchart 400.

Flowchart 400 begins at step 402. At step 402, an event selection by the user of at least one event from the among the event recommendations is accepted, the at least one event to be attended by the user. For example, and with reference to event suggestion system 102 of FIG. 2, selected event 224 may be provided to event suggestion system 102 after being selected by the user at user device 138.

In step 404, a calendar event entry corresponding to the event selection is provided to the user. For example, and with reference to event suggestion system 102 of FIG. 2, event suggestion system 102 may be configured to provide a meeting request or other type of calendar entry that corresponds to the selected event. In embodiments, such a meeting request may be generated and sent to a user's email inbox. In other embodiments, however, event suggestion system 102 may be configured to have direct calendar access and place the calendar entry directly. Flowchart 400 of FIG. 4 concludes at step 404. Other operational embodiments will be apparent to persons skilled in the relevant art(s). Note also that the foregoing general description of the operation of event suggestion system 102 is provided for illustration only, and embodiments of event suggestion system 102 may comprise different hardware and/or software, and may operate in manners different than described above.

FIG. 5 depicts a flowchart 500 of an additional example method of generating event suggestions, according to an embodiment, and wherein flowchart 500 comprises refinements or additions to the method steps of flowchart 300 as depicted in FIG. 3. Accordingly, flowchart 500 of FIG. 5 will also be described with continued reference to event suggestion system 102 of FIG. 2. However, other structural and operational embodiments will be apparent to persons skilled in the relevant art(s) based on the following discussion regarding flowchart 500.

Flowchart 500 begins at step 502. At step 502, feedback data corresponding to the attendance at the at least one event by the user is determined. For example, and with reference to event suggestion system 102 of FIG. 2, feedback data 116 may be provided from user device 138 to reinforcement learning module 222 of event suggestion system 102 after the user's attendance at selected event 224. As discussed above, feedback data 116 may be manually, automatically or semi-automatically generated by user device 138, in embodiments. Flowchart 500 of FIG. 5 concludes at step 504.

In step 504, a machine learning model based at least in part on the feedback data is updated, wherein the interest weighting factors are based at least in part on the machine learning model. For example, and with reference to event suggestion system 102 of FIG. 2, reinforcement learning module 222 of event suggestion system 102 may include a machine learning model, in embodiments, and be configured to receive feedback data 116 as shown in FIG. 2. Such feedback data may be used to update the machine learning model of reinforcement learning module 222 as described above. Other operational embodiments will be apparent to persons skilled in the relevant art(s).

As noted herein, in some embodiments, event suggestion system 102 may include one or more ML models used in the determination of suggested events 112. For instance, one or more of radius determiner 210, interest parser 212, and/or reinforcement learning module 222 may include a corresponding ML model configured to perform respective functions.

For example, in an embodiment, radius determiner 210 may include an ML model that receives user, map and calendar data 104, 106, and 108 as input, and based thereon determines travel radius 214. In another embodiment, interest parser 212 may include an ML model that receives user, map and calendar data 104, 106, and 108 as input, and based thereon determines interest weighting factors 218. Still further, reinforcement learning model 222 may include an ML model that receives feedback data 116, and generates model score(s) 220 and/or other adjustment signal received by radius determiner 210 and/or interest parser 212 for adjusting the manner in which travel radius 214 and/or interest weighting factors 218 are generated (e.g., by adjusting one or more weights, scaling factors, variables, and/or other algorithm factors of radius determiner 210 and/or interest parser 212).

Note that ML models that are present may be created by supervised or unsupervised training. In a supervised learning embodiment, each ML may be trained to perform its function. For instance, a machine learning (ML) application, such as TensorFlow™ or other ML application, may implement a machine learning algorithm to generate one or more of the ML models of radius determiner 210, interest parser 212, and reinforcement learning module 222. In an example of the generation of an ML model for radius determiner 210, the ML algorithm may receive training data versions for user, map and calendar data 104, 106, and 108, and appropriate corresponding output radius values to be trained upon. In an example of the generation of an ML model for interest parser 212, the ML algorithm may receive training data versions for user, map and calendar data 104, 106, and 108, and appropriate corresponding output interest weighting factors to be trained upon. In an example of the generation of an ML model for reinforcement learning module 222, the ML algorithm may receive training data versions for feedback data 116, and appropriate corresponding output model score(s) 220 to be trained upon. When a machine learning algorithm is implemented, it may output a model that maps the input user, map, and calendar data to the corresponding provided outputs. The ML models may be generated using any suitable techniques, including supervised machine learning model generation algorithms such as supervised vector machines (SVM), linear regression, logistic regression, naïve Bayes, linear discriminant analysis, decision trees, k-nearest neighbor algorithm, neural networks, recurrent neural network, etc.

As such, an ML model may be generated to have various forms. For instance, a model generator may generate an ML model as a vector space model, a decision tree, an algorithm (e.g., a sum or other combination of a series of variables that optionally each have coefficients) etc.

### III. Example Computer System Implementation

Each of radius determiner 210, interest parser 212, event filter 216, and/or reinforcement learning module 222, and flowcharts 300, 400 and/or 500 may be implemented in hardware, or hardware combined with software and/or firmware. For example, radius determiner 210, interest parser 212, event filter 216, and/or reinforcement learning module 222, and flowcharts 300, 400 and/or 500 may be implemented as computer program code/instructions configured to be executed in one or more processors and stored in a computer readable storage medium. Alternatively, radius determiner 210, interest parser 212, event filter 216, and/or reinforcement learning module 222, and flowcharts 300, 400 and/or 500 may be implemented as hardware logic/electrical circuitry.

For instance, in an embodiment, one or more, in any combination, of radius determiner 210, interest parser 212, event filter 216, and/or reinforcement learning module 222, and flowcharts 300, 400 and/or 500 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

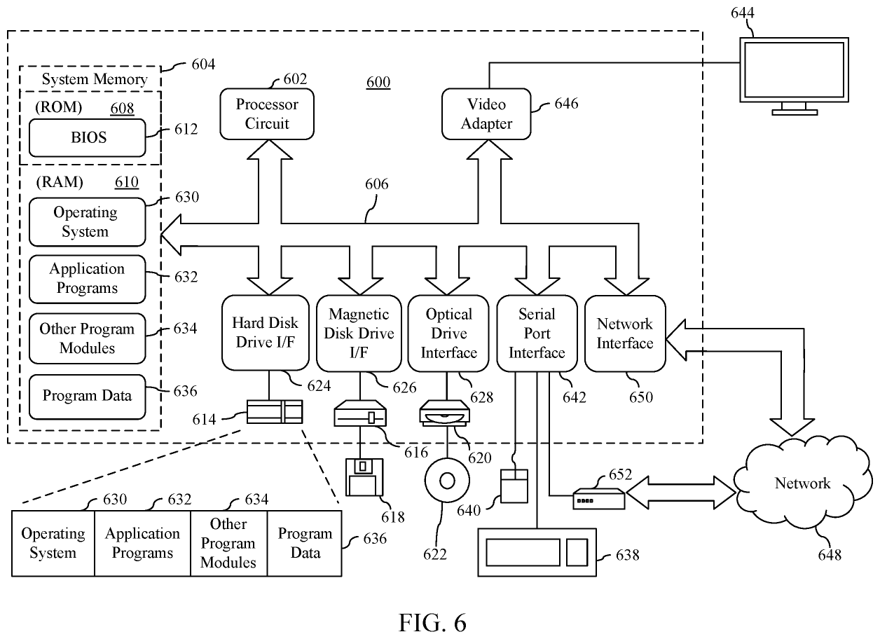

FIG. 6 depicts an exemplary implementation of a computing device 600 in which embodiments may be implemented. For example, user device 138 and server(s) 140 may be implemented in one or more computing devices similar to computing device 600 in stationary or mobile computer embodiments, including one or more features of computing device 600 and/or alternative features. The description of computing device 600 provided herein is provided for purposes of illustration, and is not intended to be limiting. Embodiments may be implemented in further types of computer systems, as would be known to persons skilled in the relevant art(s).

As shown in FIG. 6, computing device 600 includes one or more processors, referred to as processor circuit 602, a system memory 604, and a bus 606 that couples various system components including system memory 604 to processor circuit 602. Processor circuit 602 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 602 may execute program code stored in a computer readable medium, such as program code of operating system 630, application programs 632, other programs 634, etc. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computing device 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 630, one or more application programs 632, other programs 634, and program data 636. Application programs 632 or other programs 634 may include, for example, computer program logic (e.g., computer program code or instructions) for implementing radius determiner 210, interest parser 212, event filter 216, and/or reinforcement learning module 222, and flowcharts flowcharts 300, 400 and/or 500 (including any suitable step of flowcharts 300, 400 and/or 500), and/or further embodiments described herein.

A user may enter commands and information into the computing device 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 602 through a serial port interface 642 that is coupled to bus 606, but may be connected by other interfaces, such as a parallel port, game port, or a universal serial bus (USB).

A display screen 644 is also connected to bus 606 via an interface, such as a video adapter 646. Display screen 644 may be external to, or incorporated in computing device 600. Display screen 644 may display information, as well as being a user interface for receiving user commands and/or other information (e.g., by touch, finger gestures, virtual keyboard, etc.). In addition to display screen 644, computing device 600 may include other peripheral output devices (not shown) such as speakers and printers.

Computing device 600 is connected to a network 648 (e.g., the Internet) through an adaptor or network interface 650, a modem 652, or other means for establishing communications over the network. Modem 652, which may be internal or external, may be connected to bus 606 via serial port interface 642, as shown in FIG. 6, or may be connected to bus 606 using another interface type, including a parallel interface.

As used herein, the terms “computer program medium,” “computer-readable medium,” and “computer-readable storage medium” are used to refer to physical hardware media such as the hard disk associated with hard disk drive 614, removable magnetic disk 618, removable optical disk 622, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 632 and other programs 634) may be stored on the hard disk, magnetic disk, optical disk, ROM, RAM, or other hardware storage medium. Such computer programs may also be received via network interface 650, serial port interface 642, or any other interface type. Such computer programs, when executed or loaded by an application, enable computing device 600 to implement features of embodiments described herein. Accordingly, such computer programs represent controllers of the computing device 600.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A method in a computing device for generating event recommendations for user is provided herein. The method comprising: receiving user data regarding the user, calendar data corresponding to the user, map data including the current location of the user and event data corresponding to a plurality of events; determining a travel radius based at least in part on the user data, calendar data, map data, and event data; determining interest weighting factors based at least in part on the user data, calendar data, map data, and event data; applying a first filtering operation against the event data based on the determined travel radius to generate first filtered event data; applying a second filtering operation against the first filtered event data based at least in part on the calendar data to provide second filtered event data; applying a third filtering operation against the second filtered event data based at least in part on the interest weighting factors to provide third filtered event data; and generating event recommendations based at least in part on the third filtered event data.

In an embodiment of the foregoing method, the user data comprises data corresponding to the user and including at least one of social media data, an email, an SMS (short message service) message, an IM (instant message) message, interests, a contact list, or user demographics.

In another embodiment of the foregoing method, the calendar data includes at least one of free/busy data or location information corresponding to calendared events.

In one embodiment of the foregoing method, the map data includes data corresponding to the user and including at least one of navigation preferences, frequent locations, or current location.

In another embodiment of the foregoing method, the map data further includes data that enables determination of at least one of points of interest, travel directions, current traffic conditions, or predicted traffic conditions.

In one embodiment of the foregoing method, the event data comprises for each event of the plurality of events, at least one of a count of the number of persons interested the respective event, a view count of the respective event, event attributes corresponding to the respective event, or a duration of the respective event.

One embodiment of the foregoing method further comprises redetermining the travel radius based at least in part a change to at least one of user data, calendar data, map data or event data; and regenerating the event recommendations based at least in part on the redetermined travel radius.

In one embodiment of the foregoing method, the interest weighting factors are based at least in part on a machine learning model.

One embodiment of the foregoing method further comprises determining feedback data corresponding to the attendance at the at least one event by the user; and updating the machine learning model based at least in part on the feedback data.

An event recommendation system configured to receive user data, calendar data, map data and event data is provided herein. In an embodiment, the system comprises: comprises one or more processors; and one or more memory devices accessible to the one or more processors, the one or more memory devices storing software components for execution by the one or more processors, the software components including: a radius determiner component configured to determine a travel radius based at least on the user data, calendar data and map data; an interest parser component configured to determine interest weighting factors based at least on the user data, calendar data and map data; and an event filter component configured to perform filtering operations against the event data based at least on the travel radius, the calendar data, and the interest weighting factors to generate event recommendations.

In another embodiment of the foregoing system, the system further comprises a reinforcement learning component including a machine learning model that generates an output configured to form at least a partial basis for at least one of the interest weighting factors and the travel radius, the reinforcement learning module configured to: receive feedback data; and update the machine learning model based on the feedback data.

In one embodiment of the foregoing system, the user data comprises data corresponding to the user and including at least one of social media data, an email, an SMS (short message service) message, an IM (instant message) message, interests, a contact list, or user demographics.

In another embodiment of the foregoing system, the calendar data includes at least one of free/busy data or location information corresponding to calendared events.

In an additional embodiment of the foregoing system, the map data includes data corresponding to the user and including at least one of navigation preferences, frequent locations, or current location.

In another embodiment of the foregoing system, the map data further includes data that enables determination of at least one of points of interest, travel directions, current traffic conditions, or predicted traffic conditions.

In one embodiment of the foregoing system, the radius determiner component is further configured to redetermine the travel radius based at least in part a change to at least one of user data, calendar data, map data or event data, and the event filter component is further configured to regenerate the event recommendations based at least in part on the redetermined travel radius.

A computer program product is provided here, the computer program product comprising a computer-readable memory device having computer program logic recorded thereon that when executed by at least one processor of a computing device causes the at least one processor to perform operations for generating event recommendations for user, the operations comprising: receiving user data regarding the user, calendar data corresponding to the user, map data including the current location of the user and event data corresponding to a plurality of events; determining a travel radius based at least in part on the user data, calendar data, map data, and event data; determining interest weighting factors based at least in part on the user data, calendar data, map data, and event data; applying a first filtering operation against the event data based on the determined travel radius to generate first filtered event data; applying a second filtering operation against the first filtered event data based at least in part on the calendar data to provide second filtered event data; applying a third filtering operation against the second filtered event data based at least in part on the interest weighting factors to provide third filtered event data; and generating event recommendations based at least in part on the third filtered event data.

In another embodiment of the aforementioned computer program product, the operations further comprise redetermining the travel radius based at least in part a change to at least one of user data, calendar data, map data or event data; and regenerating the event recommendations based at least in part on the redetermined travel radius.

In one embodiment of the aforementioned computer program product, the interest weighting factors are based at least in part on a machine learning model.

In another embodiment of the aforementioned computer program product, the operations further comprise determining feedback data corresponding to the attendance at the at least one event by the user; and updating the machine learning model based at least in part on the feedback data.

### V. Conclusion

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A method in a computing device for generating event recommendations for user, comprising:
receiving user data regarding the user, calendar data corresponding to the user, map data including the current location of the user and event data corresponding to a plurality of events;
determining a travel radius based at least in part on the user data, calendar data, map data, and event data;
determining interest weighting factors based at least in part on the user data, calendar data, map data, and event data;
applying a first filtering operation against the event data based on the determined travel radius to generate first filtered event data;
applying a second filtering operation against the first filtered event data based at least in part on the calendar data to provide second filtered event data;
applying a third filtering operation against the second filtered event data based at least in part on the interest weighting factors to provide third filtered event data; and
generating event recommendations based at least in part on the third filtered event data.

2. The method of claim 1, wherein the user data comprises data corresponding to the user and including at least one of social media data, an email, an SMS (short message service) message, an IM (instant message) message, interests, a contact list, or user demographics.

3. The method of claim 2, wherein the calendar data includes at least one of free/busy data or location information corresponding to calendared events.

4. The method of claim 3, wherein the map data includes data corresponding to the user and including at least one of navigation preferences, frequent locations, or current location.

5. The method of claim 4, wherein the map data further includes data that enables determination of at least one of points of interest, travel directions, current traffic conditions, or predicted traffic conditions.

6. The method of claim 5, wherein the event data comprises for each event of the plurality of events, at least one of a count of the number of persons interested the respective event, a view count of the respective event, event attributes corresponding to the respective event, or a duration of the respective event.

7. The method of claim 1, further comprising:
redetermining the travel radius based at least in part a change to at least one of user data, calendar data, map data or event data; and
regenerating the event recommendations based at least in part on the redetermined travel radius.

8. The method of claim 1, wherein the interest weighting factors are based at least in part on a machine learning model.

9. The method of claim 8, further comprising:
determining feedback data corresponding to the attendance at the at least one event by the user; and
updating the machine learning model based at least in part on the feedback data.

10. An event recommendation system configured to receive user data, calendar data, map data and event data, the system comprising:
one or more processors; and
one or more memory devices accessible to the one or more processors, the one or more memory devices storing software components for execution by the one or more processors, the software components including:
a radius determiner component configured to determine a travel radius based at least on the user data, calendar data and map data;
an interest parser component configured to determine interest weighting factors based at least on the user data, calendar data and map data; and
an event filter component configured to perform filtering operations against the event data based at least on the travel radius, the calendar data, and the interest weighting factors to generate event recommendations.

11. The system of claim 10 further comprising:
a reinforcement learning component including a machine learning model that generates an output configured to form at least a partial basis for at least one of the interest weighting factors and the travel radius, the reinforcement learning module configured to:
receive feedback data; and
update the machine learning model based on the feedback data.

12. The system of claim 10, wherein the user data comprises data corresponding to the user and including at least one of social media data, an email, an SMS (short message service) message, an IM (instant message) message, interests, a contact list, or user demographics.

13. The system of claim 12, wherein the calendar data includes at least one of free/busy data or location information corresponding to calendared events.

14. The system of claim 13, wherein the map data includes data corresponding to the user and including at least one of navigation preferences, frequent locations, or current location.

15. The system of claim 14, wherein the map data further includes data that enables determination of at least one of points of interest, travel directions, current traffic conditions, or predicted traffic conditions.

16. The system of claim 10, wherein the radius determiner component is further configured to redetermine the travel radius based at least in part a change to at least one of user data, calendar data, map data or event data, and the event filter component is further configured to regenerate the event recommendations based at least in part on the redetermined travel radius.

17. A computer program product comprising a computer-readable memory device having computer program logic recorded thereon that when executed by at least one processor of a computing device causes the at least one processor to perform operations for generating event recommendations for user, the operations comprising:
receiving user data regarding the user, calendar data corresponding to the user, map data including the current location of the user and event data corresponding to a plurality of events;
determining a travel radius based at least in part on the user data, calendar data, map data, and event data;
determining interest weighting factors based at least in part on the user data, calendar data, map data, and event data;
applying a first filtering operation against the event data based on the determined travel radius to generate first filtered event data;
applying a second filtering operation against the first filtered event data based at least in part on the calendar data to provide second filtered event data;
applying a third filtering operation against the second filtered event data based at least in part on the interest weighting factors to provide third filtered event data; and
generating event recommendations based at least in part on the third filtered event data.

18. The computer program product of claim 17, the operations further comprising:
redetermining the travel radius based at least in part a change to at least one of user data, calendar data, map data or event data; and
regenerating the event recommendations based at least in part on the redetermined travel radius.

19. The computer program product of claim 17, wherein the interest weighting factors are based at least in part on a machine learning model.

20. The computer program product of claim 19, the operations further comprising:
determining feedback data corresponding to the attendance at the at least one event by the user; and
updating the machine learning model based at least in part on the feedback data.
